(19) United States
(12) Patent Application Publication
(10) Pub. No.: US 2019/0357517 A1
(43) Pub. Date: Nov. 28, 2019

(54) INSECT ATTRACTOR

(71) Applicant: LUCI CO., LTD., Tokyo (JP)

(72) Inventor: Daiki KONO, Tokyo (JP)

(21) Appl. No.: 16/482,916

(22) PCT Filed: Feb. 9, 2017
(86) PCT No.: PCT/JP2017/004754

§ 371 Date: Aug. 1, 2019

(51) Int. Cl. A01M 1/14

(52) U.S. Cl. CPC A01M 1/145; A01M 2200/012

(57) ABSTRACT

To provide a novel, small and thin insect attractor that effectively attracts insects regardless of installation location. An insect attractor having a rear panel, a front panel, and a light emitting unit is provided. The rear panel is attached to an installation surface of a site. The front panel is disposed to face the rear panel. The light emitting unit is disposed between the rear panel and the front panel. The light emitting unit includes a cylindrical portion whose both ends face the rear panel and the front panel, and emits light that attracts insects from an outer surface of the cylindrical portion toward the periphery.

### TECHNICAL FIELD

The present invention relates to an insect attractor that attracts insects by luminescence.

### BACKGROUND ART

In recent years, mixing of foreign matter into food has become a major problem. Since foreign matter contamination is a major problem for food manufacturers, many factories are particularly focused on preventing insect contamination. Specifically, monitoring has been conducted that a health management company installs insect traps in factories and restaurants, and regularly checks a site to grasp and manage the type of insects, the number of insects, invasion passages of insects and the like. There has been known an insect trap that attracts an insect with a chemical lamp and traps the insect with a fan or a sticky insect trap sheet.

For example, Patent Literature 1 discloses an LED emitter capable of performing omnidirectional irradiation, which is also used as an insect trap which irradiates ultraviolet light. As shown in FIG. 5, the radiator 20 mainly includes a cover member 21, a fixing member 22, and a plurality of LEDs 23. The cover member 21 has a cylindrical shape and extends in the longitudinal direction of the radiator 20. The cover member 21 accommodates the fixing member 22 in which the plurality of LEDs 23 and wiring and the like are arranged. The fixing member 22 is integrally formed by extrusion of aluminum and extends in the longitudinal direction of the radiator 20. While a lid 24 is attached to each of both ends of the cover member 21, many fins 25 are secured to the outer side. The radiator 20 is mounted such that its longitudinal direction is along a wall surface to be installed. The narrow angle light (ultraviolet light) emitted from the LED 23 is diffused by the cover member 21 and irradiated outside as a wide range of light so as to be most suitable for use as an insect trap.

### CITATION LIST

### Patent Literature

Patent Literature 1: JP 2016-85896 A

### SUMMARY OF INVENTION

### Technical Problem

By the way, since conventional insect traps installed in a factory etc. for the purpose of monitoring are generally large-sized, the installation location is limited, such as hanging from a ceiling or wall attachment. In addition, construction to install insect traps on a site is required, and the relocation work is not easy. Thus, it is difficult to casually install the insect trap at a place where it is desired to be installed.

The present invention has been made in view of the above circumstances, and an object thereof is to provide a novel, small and thin insect attractor that effectively attracts insects regardless of installation location.

### Solution to Problem

In order to solve such problems, the present invention provides an insect attractor including a cylindrical portion and a planar light source or a plurality of point light sources. One end of the cylindrical portion faces an installation surface of a site. The light source is disposed on an outer surface of the cylindrical portion, and emits light that attracts insects from the outer surface toward the periphery.

Here, in the present invention, a first panel portion and a second panel portion may be further provided. The first panel portion is along the installation surface of the site and faces one end of the cylindrical portion. The second panel portion faces the first panel portion and the other end of the cylindrical portion. The cylindrical portion and the light source are integrated as a light emitting unit disposed between the first panel and the second panel.

In the present invention, the light emitting unit may include a flexible substrate wound around a cylindrical portion and provided with a light source. Further, the light emitting unit may include a light-transmitting case member which accommodates the cylindrical portion and the light source. Furthermore, the light emitting unit may include a heat sink provided on an inner surface of the cylindrical portion and radiating heat generated by the light source.

In the present invention, an opening and a sticky insect trap sheet may be further provided. The opening is provided outside a portion of the second panel portion, which faces the end of the cylindrical portion, and penetrates the front and back of the second panel portion. The insect trap sheet is exchangeably attached to the first panel portion and exposed to the outside through the opening.

### Advantageous Effects of Invention

According to the present invention, the cylindrical portion is provided such that one end thereof faces the installation surface of the site, and the planar light source or the plurality of point light sources is disposed on the outer periphery of the cylindrical portion, so that it is possible to reduce the size and thickness of the insect attractor. The light emitted from the light source is projected along the installation surface to cause the installation surface to indirectly emit light. As a result, a large light emitting area can be secured, including indirect light emission on the installation surface, so that insect attracting effect can be enhanced.

### BRIEF DESCRIPTION OF DRAWINGS

FIG. 1 is an external perspective view of an insect attractor.

FIG. 2 is an expanded perspective view of the insect attractor.

FIG. 3 is an expanded perspective view of a light emitting unit.

FIG. 4 is a top view of a front panel.

FIG. 5 is an external perspective view of a conventional LED radiator.

### DESCRIPTION OF EMBODIMENTS

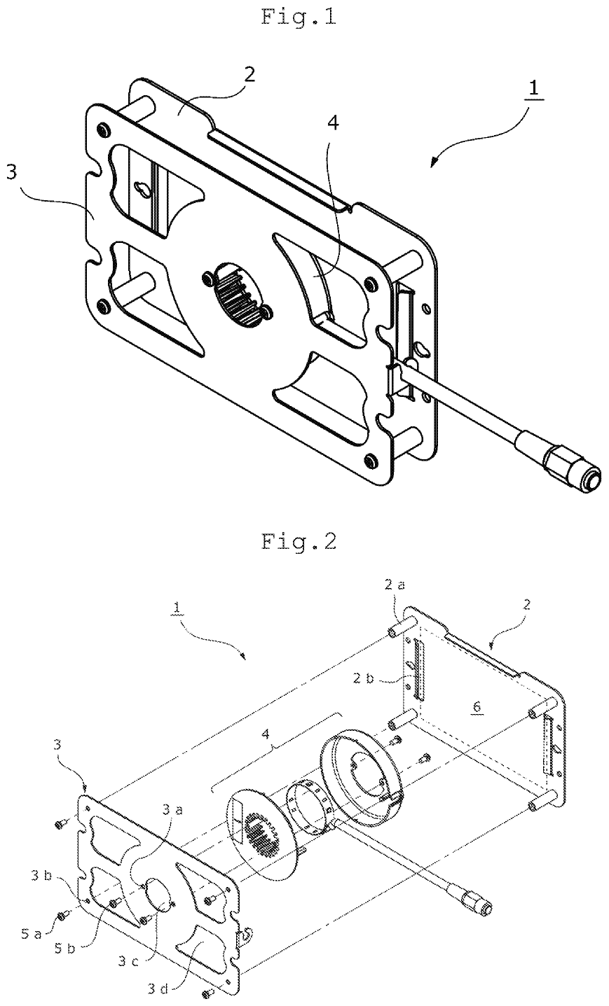

FIG. 1 is an external perspective view of an insect attractor according to the present embodiment. The insect attractor 1 attracts an insect by the light emitted by itself. The insect attractor 1 is a small and lightweight device having a postcard size, and is appropriately installed along an “installation surface” of a site (factories, restaurants, etc.) where monitoring is to be conducted that the type of insects, the number of insects, invasion passages of insects and the like are grasped and managed. Here, as the “installation surface”, a wall surface of a site and side surfaces of a desk, a work bench, a kitchen table and the like are assumed; however, because of its small size, the insect attractor can be installed flexibly regardless of the place. In addition, the insect attractor can be easily relocated to another location after the end of monitoring. As a method of installing the insect attractor 1, the insect attractor 1 may be stuck on the installation surface using a double-sided tape or the like, or may be placed on a receiver protruding forward from the installation surface. Alternatively, a stand equipped with the insect attractor 1 may be disposed in the vicinity of the installation surface. In any of the installation methods, it should be noted that the insect attractor 1 is installed such that a rear panel 2 to be described later is along the installation surface in order to cause the installation surface to indirectly emit light (however, the contact with the installation surface does not matter).

The insect attractor 1 can be used not only in factories and restaurants but also for household use, its application is not limited to monitoring, and the insect attractor 1 may be fixedly installed and used as an insect trap application. The insect attractor 1 mainly includes a pair of panels 2 and 3 arranged to face each other, and a light emitting unit 4 disposed therebetween. The light emitting unit 4 has a substantially cylindrical shape, and both ends thereof are sandwiched by the panels 2 and 3.

FIG. 2 is an expanded perspective view of the insect attractor 1. As described above, the plate-like rear panel 2 provided in the insect attractor 1 is installed along the installation surface of the site. At four corners of the rear panel 2, screw mounting portions 2a protruding forward are provided, and in each of the screw mounting portions 2a, screw holes for screwing screws 5a are provided. The depth of the insect attractor 1 is defined by a protruding height of the screw mounting portion 2a. On the surface of the rear panel 2, claw-like sheet holding portions 2b are provided at three positions that are on the left, right, and bottom sides. In the drawing, for convenience of explanation, although the lower sheet holding portion 2b is located on the upper side, at the time of actual installation, the insect attractor 1 is used upside down so that the lower sheet holding portion 2b is located on the lower side. By fitting an insect trap sheet 6 into these sheet holding portions 2b, the insect trap sheet 6 is exchangeably attached on the surface of the rear panel 2. The insect trap sheet 6 is sticky, and traps an insect in contact with the sticky surface. As the insect trap sheet 6, it is preferable to use one given a color that attracts insects (for example, yellow). When it is not necessary to provide an insect trapping function in the insect attractor 1 itself like a case where an insect trap device is separately installed, it is not necessary to provide the sheet holding portion 2b and the insect trap sheet 6.

The front panel 3 is disposed to face the rear panel 2 at an interval corresponding to the protruding height of the screw mounting portion 2a. While two screw holes 3a are provided in a central portion of the front panel 3, screw holes 3b corresponding to the positions of the screw mounting portions 2a are respectively provided at the four corners of the front panel 3. The front panel 3 is provided with a first opening 3c and a plurality of second openings 3d penetrating the front and back of the front panel 3. The first opening 3c is provided substantially in the central portion of the front panel 3 and opens in a circular shape. The second openings 3d are provided apart from the central first opening 3c, and open at four diagonal positions of the front panel 3.

The light emitting unit 4 is disposed between the rear panel 2 and the front panel 3. The light emitting unit 4 has a substantially cylindrical shape, and emits light that attracts insects toward the periphery. As such light, for example, ultraviolet light having a peak wavelength of about 360 to 370 nm can be used.

When the insect attractor 1 is assembled, first, the light emitting unit 4 is fixed to the front panel 3 using the screw 5b inserted into the screw hole 3a. Then, the front panel 3 to which the light emitting unit 4 is fixed is fixed to the rear panel 2 by screwing the screw 5a inserted into the screw hole 3b into the screw mounting portion 2a. The insect attractor 1 is disassembled by going through the procedure reverse to the assembly procedure. When the deteriorated light emitting unit 4 is replaced or when the light emitting unit 4 is replaced with the light emitting unit 4 having other optical characteristics, the replacement operation is easily performed through the above-described disassembly procedure and assembly procedure.

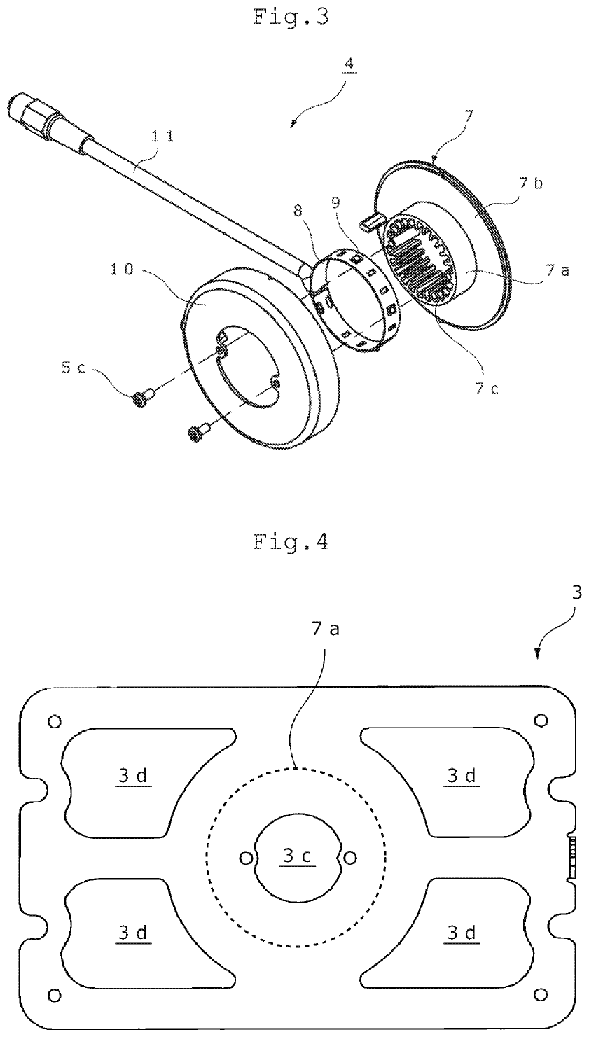

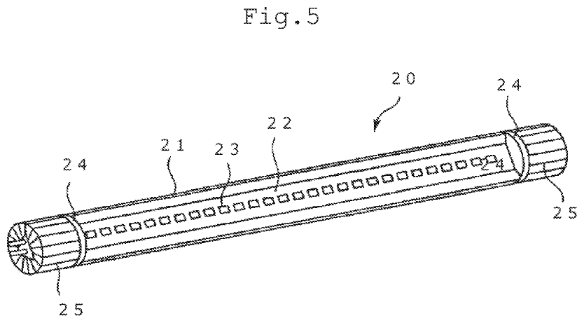

FIG. 3 is an expanded perspective view of the light emitting unit 4. The light emitting unit 4 includes a cylindrical portion 7a whose both ends face the rear panel 2 and the front panel 3, and emits light that attracts insects from an outer surface of the cylindrical portion 7a toward the periphery. In the present embodiment, the light emitting unit 4 mainly includes a base member 7, a flexible substrate 8, a plurality of LEDs 9, and a case member 10. The base member 7 has a disc portion 7b and a cylindrical portion 7a cylindrically protruding upward from the disc portion 7b. An outer surface of the cylindrical portion 7b is formed flat, and an uneven heat sink 7c for radiating heat generated by the LED 9 as a light source is provided over the entire circumference of the inner surface of the cylindrical portion 7b. Here, in order to enhance heat dissipation of the heat sink 7c, the base member 7 is preferably formed of a metal having high heat dissipation such as aluminum.

The flexible substrate 8 is wound around the periphery (outer surface) of the cylindrical portion 7a. The flexible substrate 8 has flexibility capable of following a shape of a mounting surface. Thus, the shape of the cylindrical portion 7a does not have to be cylindrical, and even if the shape of the cylindrical portion 7a is polygonal, the flexible substrate 8 can be wound without any problem. On the flexible substrate 8, the LEDs 9 which are point light sources are arranged over the entire circumference at predetermined intervals. Thereby, the light that attracts insects is emitted toward the periphery from the outer surface of the cylindrical portion 7a. As a light source, in place of using a plurality of point light sources such as the LEDs 9, a planar light source such as electroluminescence (EL) may be used to emit light in a planar manner from the outer surface of the cylindrical portion 7a. A power cord 11 is attached to the flexible substrate 8, and power for causing the LED 9 to emit light is externally supplied through the power cord 11. However, the power may be supplied by incorporating a battery in the insect attractor 1 itself instead of the power supply from the outside.

The case member 10 is formed of a material having a light transmitting property (including a semi-light transmitting property) such as a transparent plastic, and covers the entire flexible substrate 8 accommodated inside. By covering the flexible substrate 8 with the case member 10, it is possible to prevent a hand of a user (exchanger etc.) from coming into direct contact with the LED 9, so that deterioration of the LED 9 and fluctuation of characteristics can be effectively suppressed. The case member 10 may have the ability to diffuse light to diffuse the light emitted from the LED 9.

When the light emitting unit 4 is assembled, first, the flexible substrate 8 wound in a ring shape is attached to the outer periphery of the cylindrical portion 7a included in the base member 7. Next, the case member 10 is covered on the base member 7 and then screwed with the screw 5c. As a result, it is possible to obtain the light emitting unit 4 that emits the light that attracts insects from the outer surface of the cylindrical portion 7a toward the periphery.

FIG. 4 is a top view of the front panel 3. In the drawing, the circle indicated by a broken line indicates an end of the cylindrical portion 7a (or a side edge of the flexible substrate 8 wound in a circular shape). In a state where the insect attractor 1 is assembled, the first opening 3c provided substantially in the central portion of the front panel 3 faces in a hollow space provided in the cylindrical portion 7. Thus, the heat generated in the heat sink 7c is radiated to the outside through the first opening 3c, so that the heat sink 7c can be effectively cooled. For the same reason, the case member 10 is also provided with an opening.

The second opening 3d is provided outside a portion of the front panel 3, which faces the end of the cylindrical portion 7a, that is, provided apart therefrom in the diagonal direction. Thus, the insect trap sheet 6 attached to the rear panel 2 is exposed to the outside through the second opening 3d. Thereby, an insect invading from above the rear panel 2 through the second opening 3d can be efficiently trapped by the insect trap sheet 6. By providing the second opening 3d while avoiding the vicinity (especially, the outer side) of the end of the cylindrical portion 7a, it is possible to effectively prevent that the light emitted from the LED 9 is viewed directly from above the front panel 3.

As described above, according to the present embodiment, the cylindrical portion 7a is provided such that one end thereof faces the installation surface of the site, and the LEDs 9 are arranged on the outer periphery of the cylindrical portion 7a, so that it is possible to reduce the size and thickness of the insect attractor 1. By adopting such a configuration, the light emitted from the LED 9 is projected along the installation surface to cause the installation surface to indirectly emit light. As a result, a large light emitting area can be secured, including indirect light emission on the installation surface, so that insect attracting effect can be enhanced.

According to the present embodiment, the cylindrical portion 7a, the LED 9 and the like are integrated as the light emitting unit 4, and the light emitting unit 4 is disposed between the rear panel 2 and the front panel 3, so that the light emitting unit 4 can be effectively protected from impact and the like. By using the flexible substrate 8, the light emitting unit 4 can be obtained simply and inexpensively.

According to the present embodiment, the flexible substrate 8 on which the LEDs 9 are arranged is accommodated inside the case member 10, so that it is possible to effectively prevent the hand of the user (exchanger etc.) from coming into direct contact with the LED 9 when the insect attractor 1 is disassembled or assembled.

According to the present embodiment, by providing the heat sink 7c on the inner surface of the cylindrical portion 7a of the light emitting unit 4, the heat of the LED 9 absorbed by the heat sink 7c can be effectively radiated.

According to the present embodiment, the second opening 7d is provided outside the portion of the front panel 3, which faces the end of the cylindrical portion 7a, and the insect trap sheet 6 is exposed to the outside through the opening 7d, so that an insect invading from above the front panel 3 can be efficiently trapped.

In the above-described embodiment, the first panel portion (rear panel 2) and the second panel portion (front panel 3) are formed as separate members, and these panel portions are coupled by the screws 5a. However, the present invention is not limited to this and may be configured as an integral member by fixedly connecting edges of the first panel portion and the second panel portion to each other via a plate. The edges of the first panel portion and the second panel portion may be connected to each other by a hinge so as to be freely opened and closed.

In the above-described embodiment, although the insect attractor 1 incorporating the sticky insect trap sheet 6 has been described, the insect attractor 1 may have no function of trapping insects. As a means for trapping insects, a fan or the like that sucks insects by an air flow may be used.

### REFERENCE SIGNS LIST

1 Insect attractor
2 Rear panel
2a Screw mounting portion
2b Sheet holding portion
3 Front panel
3a, 3b Screw hole
3c First opening
3d Second opening
4 Light emitting unit
5a to 5c Screw
6 Insect trap sheet
7 Base member
7a Cylindrical portion
7b Disc portion
7c Heat sink
8 Flexible substrate
9 LED
10 Case member
11 Power cord

1. An insect attractor comprising:
a cylindrical portion;
a rear panel installed along an installation surface of a site, and facing one end of the cylindrical portion;
a front panel attached to the rear panel at an interval, and facing the other end of the cylindrical portion;
a planar light source or a plurality of point light sources disposed on an outer surface of the cylindrical portion and emitting light that attracts insects from the outer surface toward the periphery; and
claw-like sheet holding portions provided at the rear panel so as to hold a exchangeable insect trap sheet which is attached to a surface of the rear panel through an interspace between the one end of the cylindrical portion and a surface of the rear panel.

2. The insect attractor according to claim 1, further comprising an opening provided outside a portion of the front panel portion, which faces an end of the cylindrical portion, and penetrating the front and back of the front panel portion,
wherein the insect trap sheet is exposed to the outside through the opening.

3. The insect attractor according to claim 1, wherein the cylindrical portion and the light source are integrated as a light emitting unit disposed between the front panel and the rear panel.

4. The insect attractor according to claim 3, wherein the light emitting unit further comprises a light-transmitting case member which accommodates the cylindrical portion and the light source.

5. The insect attractor according to claim 3, wherein the light emitting unit further comprises a heat sink provided on an inner surface of the cylindrical portion and radiating heat generated by the light source.

6. The insect attractor according to claim 3, further comprising:
an opening provided outside a portion of the second panel portion, which faces an end of the cylindrical portion, and penetrating the front and back of the second panel portion; and
a sticky insect trap sheet exchangeably attached to the first panel portion and exposed to the outside through the opening.
